(19) United States
(12) Patent Application Publication
(10) Pub. No.: US 2007/0182983 A1
(43) Pub. Date: Aug. 9, 2007

(54) Threat mitigation in computer networks

(75) Inventors: Graham Richard Wyatt, Worcestershire (GB); Timothy Barry Dean, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Qinetiq Limited

(21) Appl. No.: 10/591,205

(22) PCT Filed: Feb. 28, 2005
(86) PCT No.: PCT/GB05/00726

§ 371 Date: Aug. 31, 2006

(30) Foreign Application Priority Data
Mar. 1, 2004 (GB) 0404517.5

(51) Int. Cl. G06F 3/12

(52) U.S. Cl. 358/1.15

(57) ABSTRACT

A computerised method—and related apparatus, systems, programs for a computer and signals—for securely communicating an electronic document between high and low security domains where the data format of the document is not in a predetermined set of simple data formats (for example bitmap images or ASCII text), the document is automatically converted to a data format in the set. Optionally a “lossy” transformation may also be applied to further confound attackers. The document is then conveyed securely to a user sanction function for review and sanction by a human user. Once sanctioned the document is digitally signed for onward transmission to the recipient. Especially for transmission from low domain to high domain, user sanctioning of document release may be omitted.

### FIELD OF THE INVENTION

The present invention relates to apparatus, methods, signals, and programs for a computer for security threat mitigation and document transfer in computer and communications networks and systems incorporating the same.

### BACKGROUND TO THE INVENTION

High resilience networks frequently have requirements for exchange of information with networks of low assurance, including networks of unknown threat level such as the public Internet. Traditionally, the approach to solving this problem is an air-gap between the two domains, with information exchanged between them on floppy disk. However this approach is both time-consuming and potentially risky.

This paper proposes alternative techniques to enable assured, two-way, information flow between high resilience networks and other networks of unknown threat. The techniques include conventional and novel technologies designed to control and constrain information formats, manage the environment between domains with network level controls, and provide assured, user-instigated, release sanctions.

Access to the public Internet for, for example, e-mail and web access is now almost essential even for security conscious end-users. There are other, innumerable, unclassified or low classification systems with which such security conscious networks must communicate, such as the news, weather, electronic library, route planning, and other public information networks.

There is therefore a requirement to transfer information between such low classification systems to higher classification systems that require higher assurance and a greater degree of resilience. In such a context, public Internet-connected systems are inevitably considered a high threat. Strict controls must be placed at the boundaries between these systems to prevent both the introduction of malicious content from the low system into the high system and the leakage of high data to the low system. Lower assurance arises due to the higher (or unknown) threat level, and in general is likely to lead to lower levels of resilience in applications.

Historically, the security separation problem has been solved by total electronic separation between the low and high networks. Such separation is sometimes referred to as an “air gap”. But experience has shown that a genuine air gap is not always practical, since the low classification information may have high value in the high system—for example, weather data, news, collaborative planning information between organisations, and information from public agencies.

FIG. 1 summarises information flow between such high domains 10 and low domains 20. High domains typically have clearly identified and limited users with shared motivation; the users' capabilities are known and controlled within the high domain. In contrast, low domains may have little control over who the domain users are, resulting in users with largely unknown and uncontrollable capabilities having access to the domain. It is typically such unidentifiable users who introduce the high threat level to such networks.

There is a recognised need then to provide a secure connection between such high and low networks in such a way that information can be exchanged without posing an unacceptable threat to the resilience of the high network.

It is well known to use floppy disks and CDs to transfer files between domains of unequal security level to bridge the air gap. However these simple techniques themselves introduce a number of risks and are inadequate to deal with modern threats which use multiple propagation mechanisms to gain access to networks.

Some of the dangers posed to a high assurance domain are reported widely and frequently. Examples include:
attacks against Internet facing web servers to extract client credit card details;
e-mail arriving from the Internet carrying viruses that infect a business' Intranet;
the emergence of social engineering (sometimes referred to as ‘phishing’) attacks where the attacker masquerades as an on-line retailer or bank, sending e-mails to customers inviting them to click on a web hyper-link under the pretext of performing a necessary administrative task. The attacker, who owns the web site, can then harvest the usernames, passwords and credit card details of the victims and use these credentials to gain access to the high assurance system.

Attacks can be categorised in many ways, using terms such as:
Viruses—malicious code (sometimes referred to as “malware” which replicates itself to other host programs, areas of memory, disk boot sectors, or macro capable documents. Viruses may also execute a malicious payload.
Worms—malicious code which makes copies of itself and can exploit program vulnerabilities to propagate. The propagation mechanism may alternatively be within the worm code itself.
Trojan Horses—program which do not replicate themselves but can damage the host computer or use the host to launch further attacks, often under the direct control of the attacker.

Other kinds of attacks include back doors, rootkits, BIOS and Microcode malware, social engineering attacks, and buffer overflows.

Attacks reported in the press are generally the opportunistic type that become global phenomena, such as variants of the Sobig or LoveBug viruses. Targeted attacks are less widely reported and less well understood. It is therefore difficult to determine whether their apparent lack of frequency is due to their rarity, to the unwillingness of organisations to discuss such attacks publicly, or simply to their success (i.e. the attack succeeds and is so carefully concealed that it is never discovered).

The scattergun approach taken by opportunistic attackers is a time-consuming and troublesome nuisance to system administrators who must secure their Internet facing networks from the attacks. Where these networks are connected to an affiliated high domain with high-resilience requirements, the high domain administrators must, as a result, deal with the same threats posed by the opportunistic attackers, as well as addressing the potentially more devastating targeted attacks launched by skilled and motivated attackers.

It is well known that the majority of attacks on the Internet are from relatively unskilled attackers making use of publicly available tools and code that exploit known vulnerabilities, for which manufacturers' patches are generally available. However a highly motivated and highly skilled attacker could discover new vulnerabilities, develop new means to exploit those vulnerabilities, and attack a network using such novel methods which would avoid detection by existing commercial intrusion detection and filtering systems. Such commercial systems generally detect only known recognised patterns, or signatures, of attack.

A successful attack typically compromises one or more elements of the information security trinity of information confidentiality, integrity, and availability:
Confidentiality—Information within the high domain should remain within the high domain unless its release to a lower domain is authorised and appropriate. For example, personal information relating to the clients of a bank must remain confidential and not be leaked to the Internet, either accidentally or deliberately.
Integrity—Information within the high domain should remain uncorrupted. An integrity attack might lead, for example, to a message ‘Credit Joe Bloggs £3000.00’ being changed to ‘Debit Joe Bloggs £3000.00 resulting in inaccurate bank balance information being stored.
Availability—Information services within the high domain must remain available. A well-known availability attack is the Distributed Denial of Service attack that has affected many Internet facing companies such as on-line banks and retailers. The servers of these companies are bombarded with bogus requests from thousands of computers infected with trojan horses controlled by the attacker. Valid user requests are unable to reach the server due to the overwhelming quantity of bogus traffic.

Some recent, successful and well-publicised attacks reveal a new trend for malicious code which:
has combined characteristics of virus and worm for propagation, using mobile code (active content) that usually requires some form of user interaction, as well as an element involving network attack which can happen automatically;
can embed itself into a system as a Trojan horse;
can add a back door allowing a two-way communication channel back to ‘base’ (or more likely, a web site or IRC chat room in the attacker's control) where commands or updates to the virus code can be posted.

An interesting point about such code is the diverse range of attack vectors being used for propagation. Methods include direct communication using TCP/IP, application channels such as SMTP, and corrupted application data, all being used in combination. This kind of attack can propagate using floppy disks and CDs, therefore crossing what are perceived as “air gaps” so as to threaten the resilience of critical networks where users transfer files between high and low domains by those means.

The recent Sobig.F (August 2003) attack exhibited many such characteristics. It used several propagation techniques, including spreading via e-mail attachments and network shares, and it included an embedded SMTP engine. The payload was an URL downloader which, in effect, meant that the payload was infinitely variable, being dependent upon the imagination and talent of the attacker to create their preferred attack and post the code to the web site from which the virus was pre-programmed to seek the download. The most obvious effect of the Sobig.F attack was denial of service through network flooding and e-mail system overload.

Furthermore, the number of malware attacks reported is increasing at an alarming rate. For example, the Computer Emergency Response Team (CERT) operated by Carnegie-Mellon University in the US reports the following figures:
21,756 viruses reported in 2000
114,855 viruses reported in 2003 (to October)

The propagation speed is also increasing as the number of attack vectors has increased, and as the time between the announcement of a vulnerability and the associated virus release has narrowed, sometimes to a few hours.

Yet, as noted above, such public statistics largely overlook the issue of targeted attacks, the prevalence and effects of which are almost completely unknown. Unfortunately, the threat of targeted attacks is the key concern to military networks.

The document entitled “WYSIWYS—What You See Is What You Sign (Digital Transaction Security—Marketing)” and published in 2002 by Utimaco Safeware AG (www.utimaco.com) describes a proposed solution to the problem of ensuring that the visible content of a digitally signed document remains unaltered at or following digital signing. In the system described the signed view file remains unaltered after signing so that what has been signed is subsequently what is seen. However the document states explicitly that the original electronic version of the document prior to conversion for safe signature, and which may itself contain malicious hidden components, may be forwarded along with the digitally signed version to the intended recipient. Consequently that document fails to disclose a solution to the problem of ensuring that hidden elements are not conveyed between users, particularly between users in security domains of different levels.

### SUMMARY OF THE INVENTION

According to a first aspect of the present invention there is provided a method for mitigating risks of connecting low and high assurance computer domains. It is of course also suitable for providing additional security for communication within a single security domain.

In particular there is provided a method of communicating an electronic document between security domains, the method comprising the steps of: receiving, in a first security domain, a request to transmit to a second security domain a first electronic document in a first data format capable of supporting one or more security threats; creating a second document in a second data format incapable of supporting the one or more security threats, responsive to the content of the first document; forwarding the second document in place of the first document to the second security domain.

By precluding sending of the first document which is open to security threats (in this case by forwarding the second document in place of the first, and not otherwise permitting sending of the first) no potentially concealed or malicious content associated with the one or more identified security threats can be forwarded. Different transformations and formats for the second document may be employed according to the identified threat to be countered: for example bitmap images, simple text (ASCII) format, or simple HTML with all scripting elements expunged or sufficiently modified to ensure they cannot be executed. Such modification may include for example replacing one form of bracket, brace, angle bracket, or other syntactic operator by another character or string (or indeed by simply deleting the offending characters altogether) thereby rendering the original code inoperative.

The visible content of the second document is preferably substantially the same as that of the first document, though hidden elements of the first may have been removed in creating the second document, and the visual image may be degraded so that the visual image, whilst remaining substantially the same to the human eye, is not digitally identical to the first image, so as to render any original hidden code inoperative.

In one embodiment the forwarding of the second document is conditional upon user sanction.

Furthermore the second document may be digitally signed by a sanctioning user.

The second document may be forwarded to the second security domain via at least one data diode.

The step of creating the second document may comprise performing a transformation to the first document which modifies the underlying data format of the document whilst substantially preserving the visible informational content.

The step of creating the second document may comprise adding at least one of entropy and randomness to at least one characteristic of the representation of the first document.

The at least one characteristic may comprise at least one of colour and spacing.

The step of creating the second document may comprise applying a lossy compression method.

The method may additionally comprise the step of: conveying the second document to a user sanction function for review and sanction prior to sending the second document to the second security domain.

Review and sanction may comprise sanction by a human user.

The one or more security threats may comprise presence in the first document of malicious code.

The malicious code may comprise at least one of a computer virus and a Trojan horse.

The one or more security threats comprises data steganographically concealed within the first document.

The first security domain and second security domain may—but need not—be rated at different security levels: the first security domain may be a lower-level security domain than the second security domain; or the first security domain may be a higher-level security domain than the second security domain.

In a further embodiment, the data is conveyed from the sender via electronic mail or by other file transfer mechanism.

In a further embodiment, the method is performed in response to a user request to send a document by electronic mail to a recipient in a security domain distinct from that of the sender.

According to a second aspect of the present invention there is provided apparatus arranged to perform the methods of the first aspect.

According to a third aspect of the present invention there is provided a computer system arranged to perform the methods.

According to a fourth aspect of the present invention there is provided a computer chipset arranged to perform the methods.

The invention also provides for computer software in a machine-readable form and arranged, in operation, to carry out each function of the apparatus and/or methods. In this context this includes not only source and object code, on a machine readable medium, for execution on a general purpose computer but also code intended for computer simulation of such systems or for compilation to silicon whereby the program may be implemented as a computer chipset (including the chipset comprising a single chip).

Consequently, according to a fifth aspect of the present invention there is provided a program for a computer comprising code portions arranged to perform the methods.

Preferably the method is performed on apparatus which itself offers protection against attack, for example on a computer that offers highly assured separation between trusted and untrusted processes. The precise operating system employed may be chosen according to the degree of assurance required for the specific application: for example use in banking systems may demand a highly secure operating environment. The main aim is to protect the present processes themselves against attack.

The invention also provides for systems for the purposes of communications and which comprise one or more instances of apparatus embodying the present invention, optionally combined with other additional apparatus.

The invention is also directed to novel signals employed by the other aspects of the invention.

The preferred and optional features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1 shows a schematic diagram of information transfer between domains;

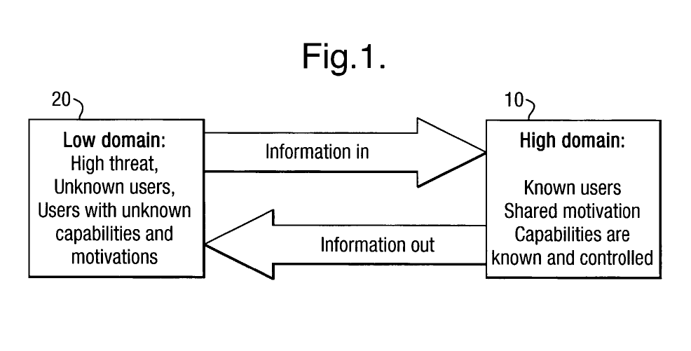

FIG. 2 shows a schematic diagram of a first system in accordance with the present invention;

FIG. 3 shows a schematic diagram of a second system in accordance with the present invention;

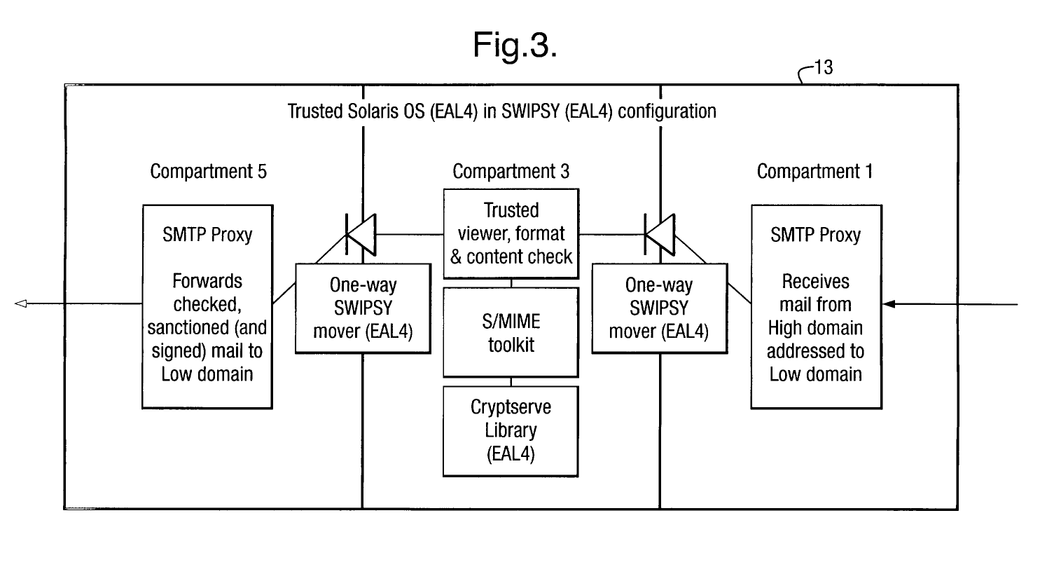

FIG. 4 shows a schematic diagram of a second system in accordance with the present invention.

### DETAILED DESCRIPTION OF INVENTION

The present inventors have identified three categories of techniques that can be used to control information flow between domains of differing security levels:
Data format control
Environment control
User control and release sanctions

Data format control techniques involve three related processes:
using inherently ‘safe’ formats,
format conversion by which data is transformed from one format to another format which utilises a different format ‘grammar’ and ‘syntax’ from that used by the original format, and
checking that the formatting rules have been obeyed.

The dangers of some complex data formats are known. For example, HTML used in web pages and e-mail can contain active content described with a scripting language which, by default, is processed and rendered by the client machine. Many attacks exploit vulnerabilities in the script interpreter or the host application to run malicious and damaging program code. Similarly, complex formats used to describe documents created with a word processor can contain macros which again perform malicious actions. Word processor formats also allow for ‘hidden content’, where multiple versions of a document are embedded within a single document description. Such files may contain data previously deleted by the user and not visible on the screen, but still encoded within the file.

Formats that ban or tightly constrain active content are safer and are in general to be preferred. Examples of such formats include earlier versions of PDF (PostScript Distribution Format), which tightly constrained the use of scripting, and banned dangerous functions such as general file access. However, such formats cannot be regarded as entirely safe since any complex language allows for the possibility of malformed data structures; these can produce unexpected behaviour in end systems, such as denial of service or buffer overflow attacks, which in effect convert a passive data structure into active code. PDF is known to suffer from such problems, and there have been documented examples of such abuse. Complex protocol specification languages such as ASN.1 (Abstract Syntax Notation One) have also been shown to suffer similar weaknesses.

One approach to solving these problems is to write document viewers and protocol implementations that are carefully crafted and exhaustively tested. In general, industry is increasingly recognising the need for this, but complex languages cause the data-space requiring testing to be huge, or in some cases unbounded. Therefore, the assurance of such applications is limited, and something further is required in high assurance environments. A ‘safe’, or at least safer, format should be incapable of such (albeit unintended) subterfuge, using simple data structures with a well-defined syntax and grammar with a finite space.

Examples of simple formats include ASCII text and (certain kinds of) bitmap images. Their simplicity aids another part of format control, the format checking.

The idea behind format conversion is that by transforming the representation of data from one form to another, possibly with several iterations, any malware capabilities contained in the original information format would be lost, especially if one of the transformation processes introduces an unpredictable, random element to the conversion process.

There are two stages at which format conversion might be used in a high assurance scenario.

First, many complex formats can be converted into ASCII text or bitmap images. For example in a Bitmap image of a Word document, all the user-visible informational content remains (the document can still be read), but all the hidden content encoded in the complex Word format is removed, along with the associated threat posed by that hidden content.

There are a number of commercial programs which can be used to take bitmap images of complex documents (in HTML, Word, Excel, Adobe Acrobat, and other formats) in a more sophisticated manner than a simple ‘Print Screen’ request. For example, these ‘screen-scrape’ programs can open a Word document so that the entire document is converted to a Bitmap image, not just the single page visible on the screen.

In addition, some of the screen-scrape programs incorporate a ‘text-scrape’ function where the text within a Word or Adobe™ formatted document can be converted to ASCII text, again removing any hidden content, though at this stage any text-scraped scripting code, for example, may be preserved.

It is worth differentiating between the effect of a screen scrape and a text scrape. The text scrape takes a document and translates the complex encoding used by the word processor to represent letters of the alphabet and translates that into simple ASCII encoding. However both encodings are used to represent letters of the alphabet. Converting a word-processed document into a (bitmap) image profoundly alters the encoding; whilst the word processor encodes letters of the alphabet, the image encodes only the colour and brightness of pixels in the image. It is only in the viewer's brain that those encodings are translated back into text.

The second time a format conversion might be performed is when releasing bitmap images, just after the format checking is completed. At this stage, the bitmap image may be transformed into a JPEG image. The transformation process, using a lossy compression algorithm like JPEG, would mean that while the information content would remain the same (the JPEG and bitmap images would appear almost identical to the viewer) the data format would undergo a transformation.

This second transformation makes it even less likely that an opportunistic attacker's hidden or malicious content can be preserved, particularly given that it may be irretrievably lost thanks to the lossy compression. Compression is of course doubly desirable given that bandwidth restrictions would make the exchange of large bitmap files difficult to scale to a large user community.

To defeat the targeted attacker it would also be possible to introduce some random alterations to the bitmap image prior to the (optional) JPEG conversion; for example, by making small, random modifications to the brightness values of some, or all, of the pixels in the bitmap, and even to the image dimensions by adding a randomly sized border to the image. The changes would be visually indiscernible to the viewer of the final image, but make it very difficult for an expert attacker to predict the exact output of the conversion and so design an attack to exploit a hypothetical vulnerability in the recipient's image viewer. Indeed the variation introduced may be varied pseudo-randomly over time to further confound attackers.

Crucially, the initial screen or text scrape conversion process does not need to be trusted or assured. However the optional process to randomise Bitmaps and the format checking stage is preferably assured.

Regarding format checking, there are an increasing number of products which are designed to check complex formats such as HTML, XML, Word, or Excel for hidden content, malicious macros, and the like. Such checkers are extremely useful and valuable in scenarios where this richness of information transfer is permissible. They can use simple heuristics such as ensuring that Word documents have not been “fast saved”. But simple heuristics are inadequate to address the full range of kind of threats discussed above.

For these situations, much more constrained data formats are required. If, for example, only two simple information formats such as ASCII text and bitmap images are allowed to be exchanged between the two domains, the scale of the problem is much reduced.

By only permitting ASCII text messages and the simplest variety of bitmap images to pass between domains, there is a significant reduction in the complexity required of the content checkers. For example, an ASCII text checker may comprise one very simple function that would eliminate from the message any characters that were not from a recognised alphanumeric list or from a small subset of permitted punctuation markings. The punctuation could even be replaced as part of the conversion by words, as in old-fashioned telegrams (“STOP” for “.”, etc.). The presence of other content raises a warning and is removed from the message before being passed on. Therefore if for example the message contains Javascript, the opening and closing brackets (‘<’ ‘>’) used to denote a ‘tag’ may be removed, rendering the Javascript incomprehensible to the receiving application. An optional, simple ASCII text search warns of the presence of blacklisted words.

A bitmap checker may be simpler still, provided the simplest kind of raw bitmap format is used exclusively. Such simple bitmaps are a rudimentary image format to parse. They contain a definition of the dimension of the image (numbers of pixels across and high) followed by the colour parameters for each of the pixels (defined for example in terms of the strength, from 0 to 255, of the Red, Green and Blue constituent colours). The bitmap format checker performs a simple grammar and syntax check of each image so that each file is known to conform to these bitmap encoding rules.

Regarding environment control, the techniques of format control discussed above must be carefully managed and protected to ensure that they cannot be subverted. Here we specifically refer to the environment at the interfaces between the high and low assurance domains. Traditional techniques to control the interface environment include firewalls, one-way data diodes (where information can only flow in one direction, for example from a low to high domain or vice versa), and the use of De-Militarised Zones, generally bounded by two firewalls or data diodes (or both).

Such a controlled environment, may be constructed using commercial off-the-shelf (COTS) components, some of which have formal (EAL) assurance rating. Such components include QinetiQ's one-way data diode (SyBard::Suite® Diode) and the SWIPSY firewall toolkit. The SWIPSY toolkit is an E3 (equivalent to EAL4) evaluated product which allows additional code to be added to its security compartments without affecting the evaluation status of the toolkit itself. SWIPSY has security properties which assure network and process separation: processes communicating with one network (for example the high domain) cannot communicate directly with the other network (for example the low domain) other than by via trusted mover agents which in turn force data to be passed to the format and content checkers.

Environment controls however are insufficient in isolation to control some malware, since the controls typically defend at the network level. However, when combined with application level ‘checker’ software and novel techniques described herein, they are vital in forcing the data through the checking processes. A number of other mechanisms must also be used if high assurance is required. These include assured user sanction, and potentially, machine virtualisation and these are discussed in more detail below.

Regarding user control and release sanctions, the assured intervention of a human user is critical for the release of data from a high domain to a low domain for two reasons. Firstly, if every exchange of information from high to low is governed by user sanction, the process can be meaningfully audited, making the users accountable for their actions. Secondly, a properly implemented and assured user sanction mechanism prevents any high domain machine infected by a back-door attack from communicating with the low domain by any route other than via the user sanctioned channel. With this restriction on information flow in place, as well as the format checking and format conversion, it becomes a significantly more challenging task for a back door program to communicate with the low domain attacker without attracting the attention of the sanctioning user.

The software used to implement the user sanction process should be simple and trusted. Firstly, the data should be presented to the sanctioning user for approval and release. This data should be confined to simple formats such as ASCII text or bitmap images as described above. Secondly, the user could, optionally, instruct the software to digitally sign the data to prevent modifications between the user's desktop and the domain boundary. The user must be able to view everything on the screen that is to be signed. This implies that a trusted viewer is used: that is, an assured computer that the user can trust will display the complete content of the message and neither this viewer nor the signer can be subverted by any attack.

The idea of a trusted signing device is a recognised requirement in some civil applications. The EU Digital Signature Directive recognises the need for a Secure Signature Creation Device (SSCD), and some EU member states have enshrined this requirement in their legislation. In addition, industry seems to be following a similar trend: the Trusted Computing Group's (TCG) Trusted Platform Module (TPM) specification includes “Data Attestation” facilities for signing data structures; and recently published documents describing Microsoft's Next Generation Computing Base (formerly Palladium™) detail aspirations for both trusted viewers and trusted signing mechanisms, as part of the trusted part of the operating system.

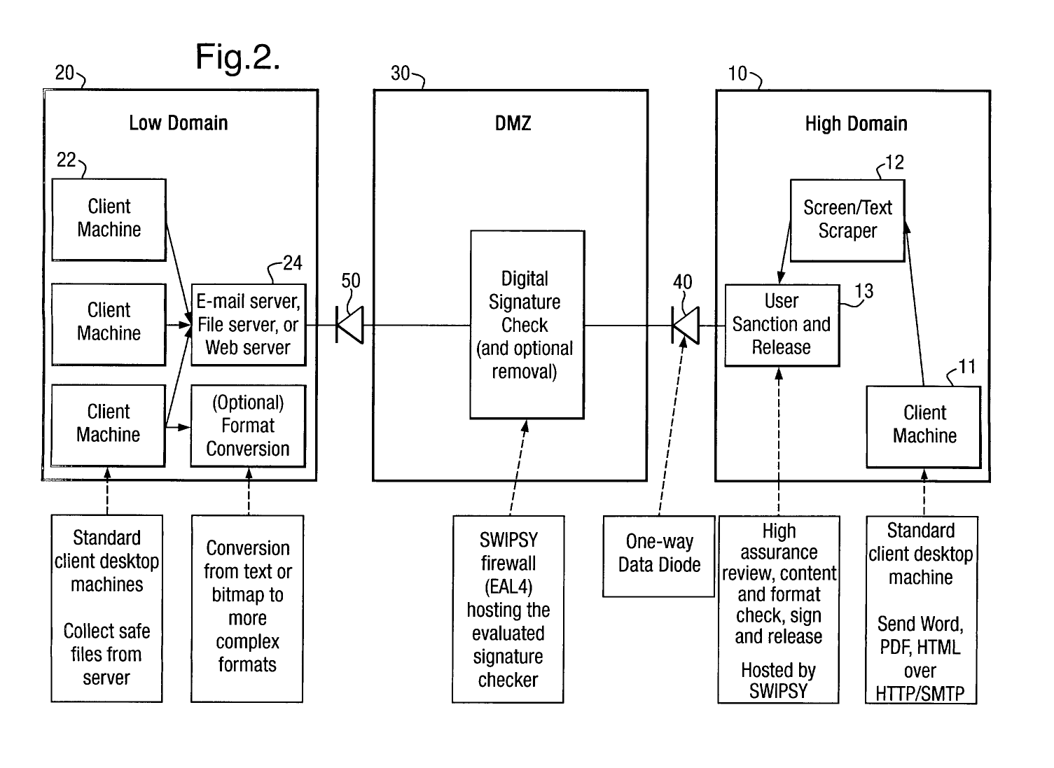

Referring now to FIG. 2, a first embodiment of an architecture for threat mitigation in computer networks—between a high-domain 10 comprising at least one client machine 11 and a low-domain 20 comprising at least one client machine 22—comprises a format converter 12 and a user sanction and release function 13.

To send data from the high domain to the low domain, an end user connects to a high domain web server 12 that can perform format conversion. Format conversion may be in the form of screen-scraping or text-scraping, essentially converting any complex file format (e.g. a Microsoft Word™ document) into a reduced functionality document (e.g. a bitmap image or ASCII text document). The converted file is then routed, via e-mail, to the user sanction release mechanism 13. The trusted user sanction device may, for example, be built upon the Trusted Solaris™ operating system (EAL4 rating) and may include an associated firewall function 40 (e.g. built upon the EAL4-rated SWIPSY toolkit).

Upon this system a console-based viewing program installed. The console viewer strips any MIME (or similar) encoding surrounding the message body (or attachment in the case of a bitmap image), performs the format check, performs any further transformation processes or black-listed word searches, and presents the ASCII text or bitmap to the user.

The reviewing user—who can be the original sender or another independent individual—can then choose to stop or release the message. If the release option is chosen, the message is digitally signed and packaged in an S/MIME envelope.

The digital signature is applied 31 using an assured cryptographic library (for example the CESG Cryptserve algorithm suite—assured to EAL4) and suitable toolkit to create the email (e.g. S/MIME) envelope. In one specific embodiment a copy of the “To:”, “From:” and other header fields from the message body are included in the envelope in order to counteract the known S/MIME weakness where header information is unsigned. However, this does not affect correct reception of the S/MIME message and checking in a standard S/MIME client.

The signed message is then forwarded to the DMZ 30 and to another SWIPSY firewall 50 (this one operating without human intervention). At the DMZ firewall the digital signature is verified 31 and (optionally) removed before it is forwarded to the low domain SMTP server.

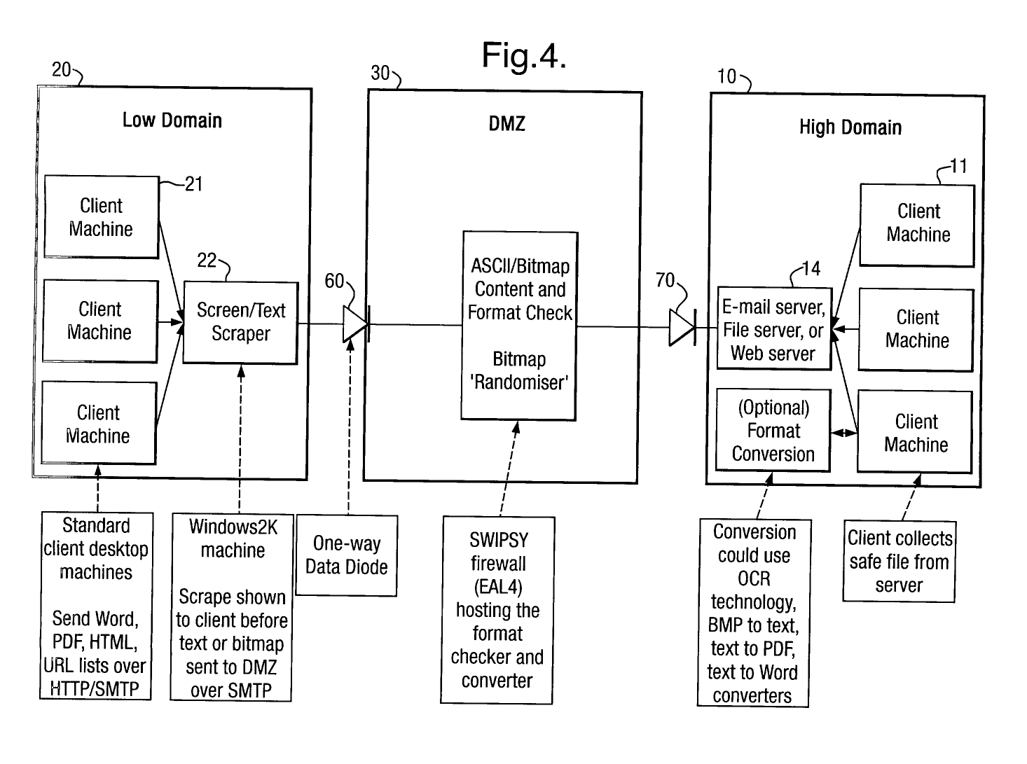

Referring now to FIG. 4, the communication route from a low domain to a high domain does not necessarily require a user sanction, although there may be good security reasons why such intervention may be required in some circumstances. This process can therefore be fully automated.

A low-domain user connects to a low domain web server that can perform screen-scrape or text-scrape 22 to converting a complex file format (e.g. a Microsoft Word document) into a simple format such as a bitmap image or ASCII text document.

The scraped file is sent through a one-way data diode 60 to the trusted format checker 32 hosted by a SWIPSY machine in the DMZ 30. The checker performs a content check on the ASCII or bitmap file as before.

If the content check is successful, the bitmap file may be ‘randomised’ and optionally transformed into another image format (e.g. JPEG format). The process of randomising introduces some variations in the original encoding to mitigate any residual risk of threats being conveyed in the precise detail of the file layout.

The transport protocol encodings that surrounded the file (e.g. MIME encoding and SMTP headers) may then be stripped off and recreated on the SWIPSY machine 32. Alternatively, protocols (such as FTP) which require no transport ‘envelope’ around the file can be used.

The checked file may then be passed to the high domain 10 through a second one-way data diode 70.

The file is delivered to the high domain server from which the client can collect the ‘safe’ file.

In an optional additional step, the file may be transformed into the original, or other higher-functionality document format (e.g. Microsoft Word format) at this stage. This might be achieved using, for example, known Optical Character Reader (OCR) software to recreate an editable file from a bitmap image. This could happen in an automated fashion in some point in the destination domain, whether upon entry to the destination domain, upon delivery to the recipient or any intervening point. This may in some circumstances reduce the robustness of the architecture with this step since it might prove possible for any ‘malware’ in the original document to be reconstructed as part of this process.

It can be seen that the data diodes 40, 50, 60, 70 illustrated in the diagrams above are directed in opposite directions, thereby creating a two-way flow of data between high and low that might appear to make the data diodes redundant. However, the high and low domains illustrated in the diagrams are generic labels and not meant to imply that the low domain is the same low domain in both diagrams. Rather, the scenarios described in this paper are assuming the high domain has a multiplicity of logically distinct connections to lower domains.

In the embodiments described above an architecture is presented which imposes stringent constraints on the information transfer between high and low domains. Other embodiments may require a ‘richer’ exchange of information, involving more complex file types and data encodings than simple ASCII text and Bitmap images. Examples of such formats include PDF files and database updates. For such kinds of files, complex file types may be transformed into a single, standard XML representation. Such a complex—but uniform—XML would then be subjected to content checking on a trusted platform, and then transformed from the XML back to the original encoding (e.g. Microsoft Word) or to a new encoding (e.g. PDF format).

Machine Virtualisation allows a second complete operating system to be installed on a user's machine and for that second operating system to run concurrently as a second ‘virtual’ machine with the host operating system. Virtual machine software such as VMWare™ allows many such virtual machines to operate simultaneously. Virtual machine technology may be used to create secure multi-system desktops where the two virtual machines are separated by known assured mechanisms.

Preferably, the trusted user sanction mechanism is built into a separate virtual machine on the client's desktop. Such an arrangement may make use of an assured and highly locked-down Operating System that is specifically for this one purpose. Such an architecture adds flexibility and convenience, allowing users to release documents from their own desktops, either to replace or supplement the independent trusted ‘domain’ signatory described above. Where it supplements the independent signatory it effective enforces a two-person rule release mechanism.

In summary then, a combination of techniques is proposed to allow a potentially assured, two-way exchange of information between high and low assurance domains. The architecture potentially offers greater security than an air-gap since whilst an air-gap is an attractive idea in theory it is often difficult to achieve in practice: pragmatic users faced with an air-gap between security domains will often reach for a floppy disk or USB memory stick rather than re-type the entire document from the high machine to the low.

The combination of format controls, environment controls, and user controlled release sanctions outlined above have been designed to offer a secure solution to the urgent and unavoidable business requirement to share information.

Any range or device value given herein may be extended or altered without losing the effect sought, as will be apparent to the skilled person for an understanding of the teachings herein.

1. A method of communicating an electronic document between security domains, the method comprising the steps of:
receiving, in a first security domain, a request to transmit to a second security domain a first electronic document in a first data format capable of supporting one or more (covert) security threats;
creating a second document in a second data format incapable of supporting the one or more security threats, responsive to the content of the first document;
forwarding the second document in place of the first document to the second security domain.

2. A method according to claim 1 in which forwarding of the second document is conditional upon user sanction.

3. A method according to claim 1 in which the second document is digitally signed by a sanctioning user.

4. A method according to claim 1 in which the second document is forwarded to the second security domain via at least one data diode.

5. A method according to claim 1 in which the step of creating the second document comprises performing a transformation to the first document which modifies the underlying data format of the document whilst substantially preserving the visible informational content.

6. A method according to claim 1 in which the step of creating the second document comprises adding at least one of entropy and randomness to at least one characteristic of the representation of the first document.

7. A method according to claim 6 in which the at least one characteristic comprises at least one of colour and spacing.

8. A method according to claim 1 in which the step of creating the second document comprises applying a lossy compression method.

9. A method according to claim 1 comprising the step of:
conveying the second document to a user sanction function for review and sanction prior to sending the second document to the second security domain.

10. A method according to claim 1 in which review and sanction comprises sanction by a human user.

11. A method according to claim 1 in which the one or more security threats comprise presence in the first document of malicious code.

12. A method according to claim 11 in which the malicious code comprises at least one of a computer virus and a Trojan horse.

13. A method according to claim 1 in which the one or more security threats comprises data steganographically concealed within the first document.

14. A method according to claim 1 in which the first security domain and second security domain are rated at different security levels.

15. A method according to claim 1 in which the first security domain is a lower-level security domain than the second security domain.

16. A method according to claim 14 in which the first security domain is a higher-level security domain than the second security domain.

17-21. (canceled)

22. Apparatus for communicating an electronic document between security domains, the apparatus comprising:
apparatus arranged to receive, in a first security domain, a request to transmit to a second security domain a first electronic document in a first data format capable of supporting one or more (covert) security threats;
apparatus arranged to create a second document in a second data format incapable of supporting the one or more security threats, responsive to the content of the first document;
apparatus arranged to forward the second document in place of the first document to the second security domain.

23. A computer chipset for communicating an electronic document between security domains, the computer chipset comprising:
a first component arranged to receive, in a first security domain, a request to transmit to a second security domain a first electronic document in a first data format capable of supporting one or more (covert) security threats;
a second component arranged to create a second document in a second data format incapable of supporting the one or more security threats, responsive to the content of the first document;
a third component arranged to forward the second document in place of the first document to the second security domain.

24. A computer readable medium having program code record thereon to direct a computer to communicate an electronic document between security domains, the program comprising:
a first code portion arranged to receive, in a first security domain, a request to transmit to a second security domain a first electronic document in a first data format capable of supporting one or more (covert) security threats;
a second code portion arranged to create a second document in a second data format incapable of supporting the one or more security threats, responsive to the content of the first document;
a third code portion arranged to forward the second document in place of the first document to the second security domain.
